(19) United States
(12) Patent Application Publication
(10) Pub. No.: US 2014/0081490 A1
(43) Pub. Date: Mar. 20, 2014

(54) SYSTEM AND METHOD OF CONVERTING A STANDARD HYBRID VEHICLE INTO A PLUG-IN HYBRID ELECTRIC VEHICLE (PHEV)

(71) Applicant: Kim ADELMAN, Poway, CA (US)

(72) Inventor: Kim ADELMAN, Poway, CA (US)

(73) Assignee: Plug-In Conversions Corporation, Poway, CA (US)

(21) Appl. No.: 13/615,824

(22) Filed: Sep. 14, 2012

(51) Int. Cl. B23P 23/04; H02J 7/00; H01R 13/44; B60W 20/00

(52) U.S. Cl. 701/22; 320/109; 439/135; 320/130; 29/33 R; 180/65.29; 903/903

(57) ABSTRACT

A kit for converting a standard hybrid vehicle into a plug-in hybrid vehicle (PHEV) is described. The kit includes at least one battery configured to match the voltage of an original hybrid battery; connection hardware, wherein the connection hardware is configured to electrically connect the at least one battery to an off-vehicle power source; and tangible computer readable memory media storing battery management software, wherein when executed in a processor in a vehicle, the battery management software is configured to provide information relating to battery performance to an engine control unit, wherein the at least one battery is further configured to maintain charge balance between each of the cells of the at least one battery.

### FIELD

The technology relates to the field of electric and hybrid vehicles, and more particularly to a system and method of converting a standard hybrid vehicle into a plug-in hybrid electric vehicle (PHEV).

### BACKGROUND

Standard hybrid vehicles are typically vehicle that uses two or more distinct power sources to move the vehicle. Hybrid electric vehicles (HEVs) typically combine an internal combustion engine and one or more electric motors. Hybrid electric vehicles, which are currently manufactured, include the Toyota® Prius®. In accordance with an exemplary embodiment, it would be desirable to convert standard hybrid electric vehicles (HEV) into plug-in hybrid vehicles (PHEV).

### SUMMARY

In accordance with an exemplary embodiment, a kit for converting a standard hybrid vehicle into a plug-in hybrid vehicle (PHEV), the kit comprises: at least one battery configured to match the voltage of an original hybrid battery; connection hardware, wherein the connection hardware is configured to electrically connect the at least one battery to an off-vehicle power source; and tangible computer readable memory media storing battery management software, wherein when executed in a processor in a vehicle, the battery management software is configured to provide information relating to battery performance to an engine control unit, wherein the at least one battery is further configured to maintain charge balance between each of the cells of the at least one battery.

In accordance with another exemplary embodiment, a portable recharging kit for an electric vehicle, the kit comprises: an external source of electricity, which is configured to be stored within the electric vehicle; connection hardware, which is matable with an electric vehicle compliant connector; and one or more cables, which connects the connection hardware to the external source of electricity.

In accordance with a further exemplary embodiment, a panel assembly, which is configured to fit within a front bumper of an electrical vehicle, which comprises: a back plate, which is attachable to an inner portion of the front bumper; a door assembly, which is attachable to the back plate, the door assembly including a door, a latch catch and magnet assembly, a hinge, and a hinge bracket, which allows the door to swing outward from a closed position to expose an electric vehicle compliant connector, which is housed within the front bumper of the electric vehicle and recharges the electric vehicle as needed.

In accordance with another exemplary embodiment, a method of increasing the performance of at least one battery configured for use in a PHEV, wherein the at least one battery is configured with the same maximum voltage as an original vehicle battery, the method comprises: controllably cycling the charging and discharging of the at least one battery, the cycling comprises: battery charging, wherein the at least one battery is charged to a first state of charge in charging cycling, and discharging, wherein discharging comprises: regular discharging, wherein the at least one battery is discharged to second state of charge, and deep discharging, wherein the at least one battery is discharged to a third state of charge.

In accordance with a further exemplary embodiment, a method of maximizing battery usage in a PHEV, wherein the cycling of a vehicle battery increases battery performance and battery life, the method comprises: requesting vehicle operator input relating to desired vehicle operation mode; requesting vehicle operator input relating to estimated trip length; requesting information relating to battery charge parameters; allowing vehicle operation in the user requested mode when battery criteria exceed threshold levels; denying vehicle operation in the user requested mode when battery criteria fail to exceed threshold levels; and limiting a rate of battery power availability according to predetermined criteria, wherein the predetermined criteria are created to maximize ideal cycling of the vehicle battery during each trip, wherein ideal cycling comprises discharging the vehicle battery from a first state of charge to a second state of charge.

The foregoing is a summary and thus contains, by necessity, simplifications, generalization, and omissions of detail; consequently, those skilled in the art will appreciate that the summary is illustrative only and is not intended to be in any way limiting. Other aspects, features, and advantages of the devices and/or processes and/or other subject matter described herein will become apparent in the teachings set forth herein. The summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

FIG. 1 illustrates a kit for converting a hybrid vehicle in to a plug-in hybrid electric vehicle (PHEV) in accordance with an exemplary embodiment.

FIG. 2 illustrates a door frame assembly mounted on a rear bumper of a plug-in hybrid electric vehicle, which houses the connection hardware for a plug-in hybrid electric vehicle (PHEV).

FIG. 3 illustrates a perspective view of an electrical connector and door frame assembly for converting a hybrid into a plug-in hybrid electric vehicle (PHEV) in accordance with an exemplary embodiment.

FIG. 4 illustrates a perspective view of the frame as shown in FIG. 3 for converting a hybrid into a plug-in hybrid electric vehicle (PHEV) in accordance with an exemplary embodiment.

FIG. 5 illustrates a perspective view of the door as shown in FIG. 3 for converting a hybrid into a plug-in hybrid electric vehicle (PHEV) in accordance with an exemplary embodiment.

FIG. 6 illustrates a perspective view of a bracket for converting a hybrid into a plug-in hybrid electric vehicle (PHEV) or electric vehicle (EV) in accordance with an exemplary embodiment.

FIGS. 7A-7E illustrate examples of a user interface display in accordance with an exemplary embodiment.

FIG. 8 illustrates a portable recharging kit, which provides a source of electricity for use with an electric vehicle (EV) and/or a plug-in electric vehicle (PEV) in accordance with an exemplary embodiment.

FIG. 9 illustrates a front panel frame assembly mounted on a front bumper of a plug-in electric vehicle, and which houses an electric vehicle supply equipment (EVSE) connector.

FIG. 10 illustrates the front panel frame assembly as shown in FIG. 9 from a front side in accordance with an exemplary embodiment.

FIG. 11 illustrates the front panel frame assembly as shown in FIG. 9 from a back side view.

FIG. 12 illustrates a perspective view of the back plate of the front panel frame assembly as shown in FIGS. 10-11.

FIG. 13 illustrates a side view of the back plate as shown in FIG. 12.

FIG. 14 illustrates a perspective view of the hinge bracket of the front panel assembly in accordance with an embodiment.

FIG. 15 illustrates a perspective view of another bracket for receiving an electrical connector for a plug-in electric vehicle (PHEV) and/or electric vehicle (EV) in accordance with an embodiment.

### DETAILED DESCRIPTION

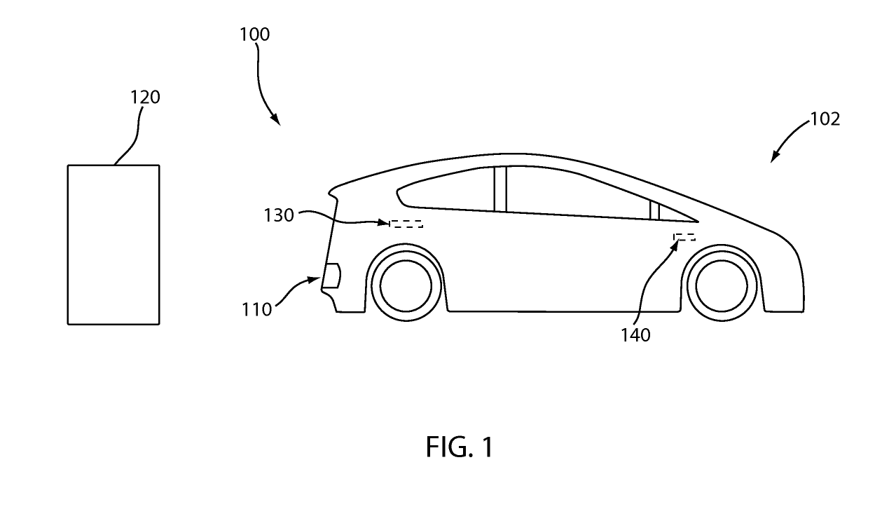

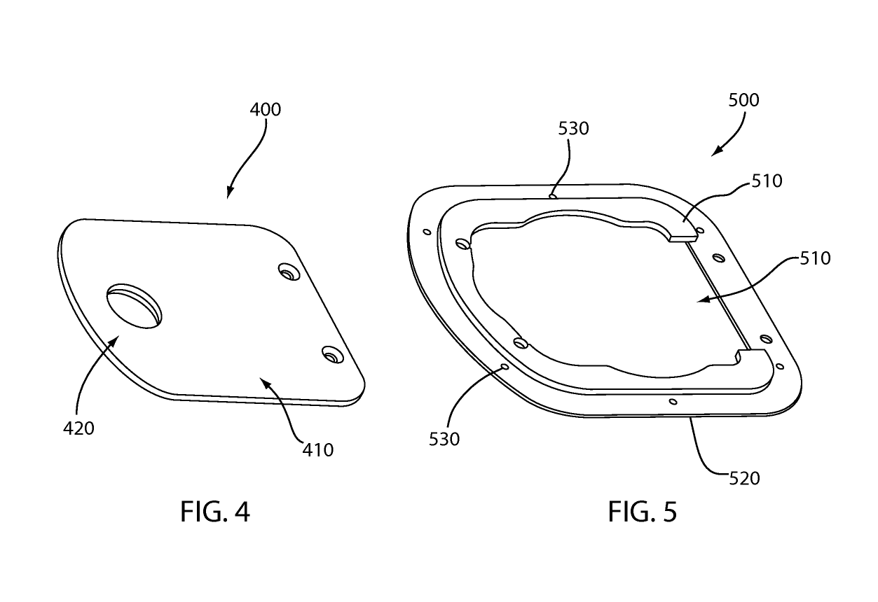

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the FIGS. 1-8, can be arranged, substituted, combined, and designed in a wide variety of different configurations, all of which are explicitly contemplated and make part of this disclosure.

Some embodiments disclosed herein relate generally to electric vehicles, and/or vehicles, which are at least partially powered by electricity and methods of making and using such systems. In addition, some embodiments relate to the individual components and subparts of the systems described herein, as well methods of making and using the same. Some embodiments relate to systems, components and methods for converting a vehicle into a vehicle that is at least in part a plug-in electric vehicle and/or systems, and components. For example, without being limited thereto, the systems and methods can be used for cars, trucks, vans, tractor trailers, boats, air-vehicles, motorcycles and the like.

FIG. 1 illustrates a kit for converting a hybrid vehicle in to a plug-in hybrid electric vehicle (PHEV) in accordance with an exemplary embodiment. As shown in FIG. 1, the kit 100 includes connection hardware 110, wherein the connection hardware is configured to electrically connect at least one battery 120 to an off-vehicle power source 130. The at least one battery 120 is preferably configured to match the voltage of the original hybrid battery. The kit 100 also preferably includes battery management software (BMS) 140, wherein the battery management software 140 is configured to provide information relating to battery performance to an engine control unit (not shown). In addition, the at least one battery 120 is further configured to maintain charge balance between each of the cells of the battery.

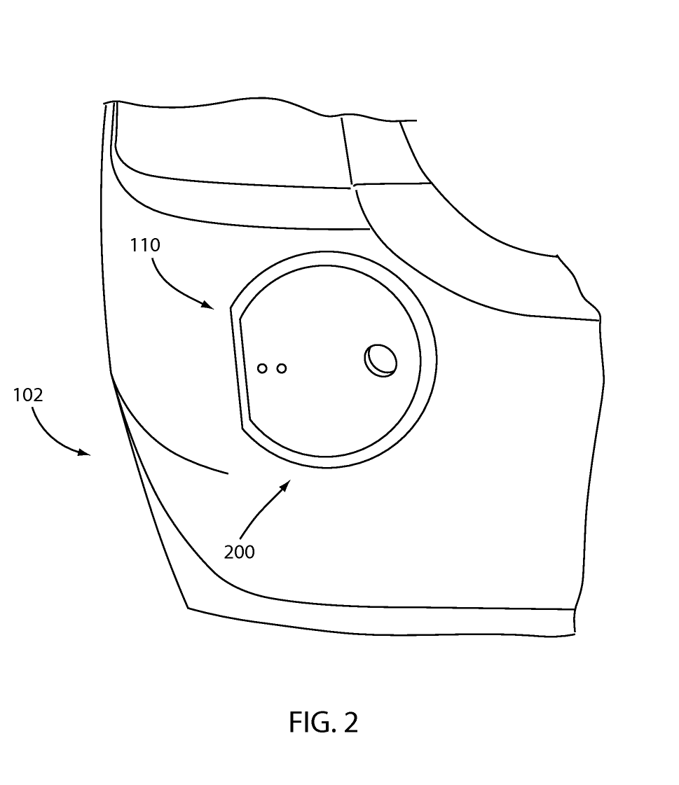

In accordance with an exemplary embodiment, the connection hardware 110 can comprise an electrical connector such as, for example an SAE J1772 compliant or dc equivalent electrical connector (FIG. 2). The connection hardware 110 can additionally comprise communication hardware (not shown). The communication hardware can include wireless transmitter and receiver hardware, Ethernet technology and wiring, or any other communication hardware. Thus, some embodiments relate to power users, converted or factory built having one or more of the functionalities and/or components described below and elsewhere herein. Some embodiments relate to conversion kits for converting a vehicle into a PHEV and/or a vehicle as described herein.

In an exemplary embodiment, a hybrid vehicle or an electric vehicle can be configured with a kit 100 to convert the hybrid vehicle into a plug-in electric vehicle. The vehicle 102 can be configured with at least one battery 110 with the energy of from 1 to 200 kilowatt hour (kWh) and a usable energy of between 0.6 kWh and 180 kWh, a capacity between 2 Ampere-hour (Ah) and 200 Ah, and a voltage ranging from 12 to 500 volts of direct current (Vdc). In accordance with another exemplary embodiment, the vehicle can be configured with a battery with the energy of 1.3 kilowatt hour (kWh) and a usable energy of 0.78 kWh or approximately sixty percent of the total charge, a 6.5 Ampere-hour (Ah) capacity, 201.6 Vdc, and can provide approximately a five mile range. The vehicle can be configured with a battery with the energy of 6.1 kWh and a usable energy of 4.27 kWh or approximately seventy percent of the total charge, a 30 Ah, 201.6 Vdc, and can provide a 25 mile range. The vehicle can be configured to have a battery with the energy of 12 kWh and a usable energy of 8.5 kWh or approximately seventy percent of the total charge, 50 Ah, 201.6 Vdc, and can provide a 40 mile range. In accordance with an exemplary embodiment, the batteries can be configured for charging. The battery can be configured for charging at up to two-hundred forty (240) Vdc and up to 120 A. A person of skill in the art will recognize that a battery can be configured with a broad range of energy, usable energy, voltage, and charge to provide a variety of ranges and functionality and that the present disclosure is not limited to the above listed examples.

In accordance with an exemplary embodiment, the vehicle can be configured with off-the-shelf batteries. The vehicle can be configured with batteries configured to a desired size, weight, and power storage ability. In some aspects, the voltage of a battery can be configured to match the voltage, amperage and type of the original vehicle battery. For example, the vehicle can be configured with nickel metal hydride batteries configured to match the battery characteristics of the original vehicle batteries. These characteristics can include, for example, battery voltage. In accordance with an exemplary embodiment, the matching of the voltage of the replacement battery with the original battery enables continued use of several of the vehicle systems and thus simplifies the conversion.

In an exemplary embodiment, a converted vehicle can include a vehicle mounted battery charger. The battery charger can be configured to receive a variety of electrical inputs and to provide a variety of electrical outputs. In one embodiment, a vehicle charger can be configured to receive inputs ranging from 90 volts of alternating current (Vac) to 260 Vac. A variation in input voltage into a charger can alter charger power output. For example, the charger can provide between 0.1 kW and 3 kW of power, and more specifically 1 kW of power when the charger is provided with 120 Vac and the charger can provide between 0.1 kW and 4 kW of power, and more specifically 1.6 kW of power when the charger is provided with 240 Vac. Alternatively, a charger receiving power at 120 Vac can, for example, be configured to provide a 5 A charge in approximately five hours and a charger receiving power at 240 Vac can be configured, for example, to provide a 6.8 A charge in approximately four to five hours. A person skilled in the art will recognize that a charger can receive a variety of inputs and create a variety of outputs and is not limited to the specific embodiments of the present disclosure.

Some embodiments of a hybrid vehicle configured for a plug-in electric vehicle (PHEV) can include a vehicle generator, which is configured to generate electricity using vehicle energy resources such as chemical energy, potential energy, kinetic energy, or any other source of vehicle energy. The generator can be mechanically connected to an internal combustion engine, and can thereby generate electricity. A generator can be configured to generate a broad range of power. In some specific embodiments, a generator can be configured to generate 125 A and 25 kW of electricity. In further embodiments, a generator can be configured to generate approximately 10 kWh when the internal combustion engine is running at idle. In additional aspects, a generator can be configured to generate approximately 10 kWh of electricity from a gallon of gasoline. A person of skill in the art will recognize that the present disclosure is not limited, to any specific configuration of generator but encompasses all known configurations.

In some further embodiments, this conversion of a vehicle to have plug-in conversion capability may include converting a hybrid vehicle to a plug-in hybrid electric vehicle (PHEV). Some embodiments herein relate to kits for converting a hybrid vehicle to a PHEV. The kits may include, for example, any of the components described herein, including one or more of: at least one battery, suspension components, at least one battery charger, mating connector hardware, at least one cooling fan, and/or a battery management system.

A vehicle can be converted to a plug-in hybrid electric vehicle (PHEV) with the addition of conversion components. In accordance with an exemplary embodiment, some or all of these components may be collected into a conversion kit. These components can include, for example, one or more of the following: at least one battery, suspension components, at least one battery charger, mating connector hardware, at least one cooling fan, and/or a battery management system.

In some embodiments in which a vehicle is converted to a plug-in hybrid electric vehicle (PHEV), the original batteries of the vehicle can be supplemented or replaced by additional energy storage capacity, which can, comprise additional batteries. The additional batteries can comprise a variety of battery types having a variety of sizes, including, for example, lithium-ion, nickel metal hydride (NiMH) batteries and the like. A person skilled in the art will recognize that the present disclosure is not limited to the specifically disclosed battery types, but may include any battery capable of achieving desired functionality and/or output.

The batteries can be configured to match the voltage output of the vehicle's original batteries while increasing the current capacity of the original batteries. A person skilled in the art will recognize a variety of techniques that can be used to increase the capacity of batteries while matching the voltage output to that of the original vehicle battery. In one embodiment, for example, the original 6.5 ampere-hour, 201.6 Vdc battery found in a Toyota Prius can be replaced by a 30 ampere-hour, 201.6 Vdc battery. In embodiments in which the replacement battery is a nickel metal hydride battery, the battery can comprise one-hundred sixty-eight, 1.2 Vdc cells connected in series to achieve the required voltage and amperage. The matching of the voltage output of the new batteries to that of the original batteries can enable use of several original components of the vehicle and thereby greatly simplify the conversion process.

A conversion kit 100 can additionally include replacement suspension components to counteract any weight changes caused by the conversion. A person of skill in the art will recognize that the addition or removal of components from a vehicle may alter the overall vehicle weight as well as the center of gravity. This can result in drivability and performance changes. Replacement of certain suspension components can minimize these changes in performance and drivability. In some embodiments in which, for example, weight is added to the rear of the vehicle in the form of batteries, suspension components may include stiffer springs and/or shock absorbers with a higher damping coefficient. A person of skill in the art will recognize that a wide variety of adjustments can be made to a suspension to counteract the effects of weight and center of gravity change on a vehicle and the present disclosure is not limited to any specific suspension configurations.

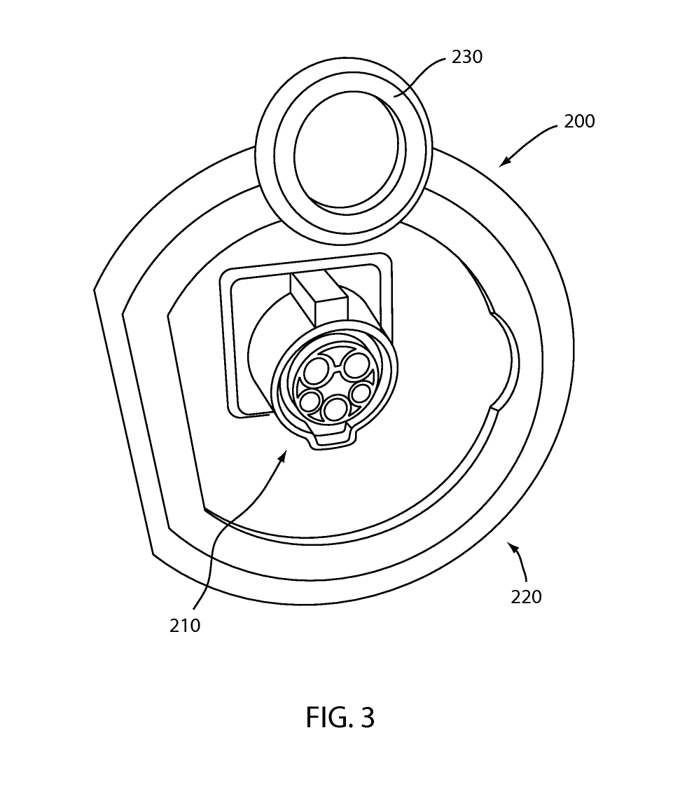

A conversion kit 100 further can include mating connector hardware 110 as shown in FIGS. 2-6. As shown in FIGS. 2-6, the mating connector hardware 110 preferably includes a plug receptacle assembly 200, which includes an electrical connector 210 and a door assembly 220. As shown in FIGS. 1 and 2, the plug receptacle assembly 200 is preferably installed within or attached to a rear panel or side panel of the vehicle, which provides access to the at least one battery 130, which is placed within a rear portion or the trunk of the vehicle 102. The plug receptacle assembly 200 is preferably configured to receive a SAE J1772 compliant or dc equivalent electrical connector 210. As shown in FIG. 3, the electrical connector 210 preferably includes a rubber or rubber-like cap 230, which covers the electrical connector 210 when not in use.

In accordance with an exemplary embodiment, the plug receptacle assembly 200 includes a door 400, a door frame 500, and bracket assembly 600. As shown in FIGS. 3-5, the door frame assembly 220 includes a door 400, which is housed within a door frame 500. The door 400 has a generally oval and/or rectangular shape 410 thereto and is sized and shaped to fit within an interior of the door frame 500. The door frame 500 also has a generally oval and/or rectangular shape thereto with an opening therein 510, which provides access to the electrical connector 210. The door 400 preferably has an opening or handle portion 420, which provides the user and/or operator with the ability to open the door 400 and obtain access to the interior portion thereof and the electrical connector 210. Once the door 400 is opened, the electrical connector 210 receives an external charge coupler (not show), which charges the batteries of the vehicle. In accordance with an exemplary embodiment, the door 400 includes one or more magnetic elements (not shown), which helps secure the door against the door frame 500.

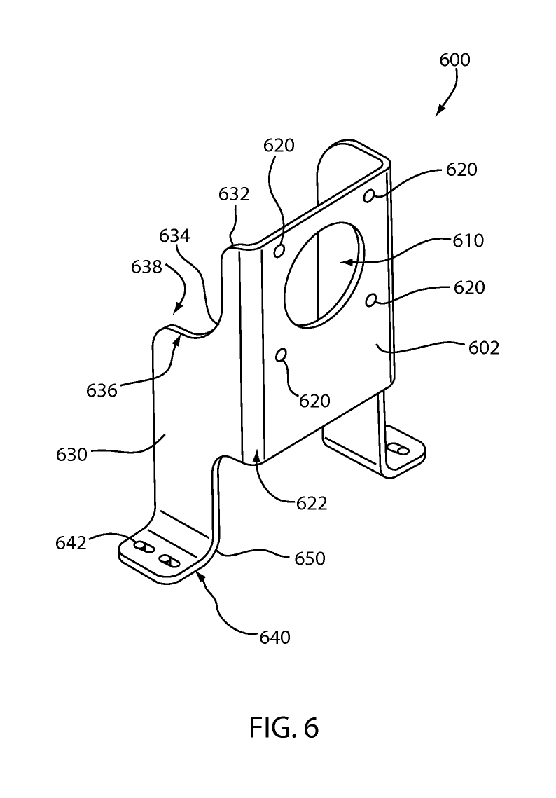

In accordance with an exemplary embodiment, the door 400 is attached to the door frame 500 via a hinge (not shown). The hinge preferably includes a spring or spring like device, which assists with the opening and closing of the door 400. As shown in FIG. 5, the door frame 500 includes an inner frame 510, which allows an outer surface of the door 400 to fit relatively flat or smooth surface with the body (or panel) of the vehicle 102. The outer frame 520 fits tightly and/or is secured to a panel of the vehicle 102. The outer frame 520 also includes one or more openings 530 to secure the door frame 500 to the panel of the vehicle 102. In accordance with an exemplary embodiment, the door 400 and door frame 500 are made from a plastic or plastic-like material.

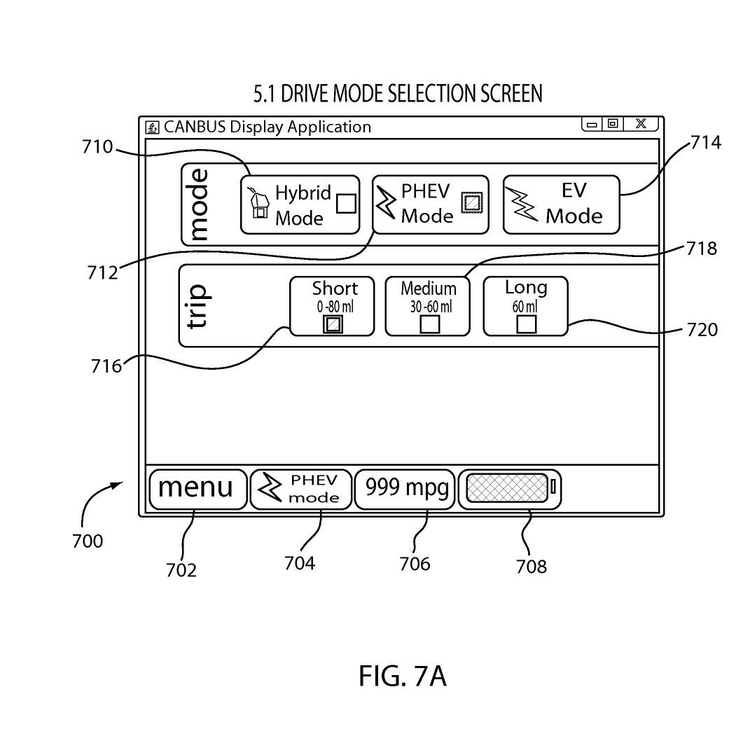

In accordance with an exemplary embodiment, as shown in FIG. 6, the electrical connector 210 (FIG. 3) fits within a bracket 600. The bracket 600 preferably includes relatively flat face plate 602 having a connector opening 610, which houses the electrical connector 210, and a plurality of openings 620, which surround the connector opening 610. The plurality of openings 620 are preferably configured to attach or secure the electrical connector 210 to the bracket 600. A pair of side panels 630 are positioned at an approximate 90-degree angle to the face plate 602, and extends downward to flange 640. The transition 622 from the face plate 610 to the pair of side panels 630 preferably has a slight curvature or roundness thereto rather than sharp edge. Each of the side panels 630 has rounded edge 632, which extends downward to a curved inner portion 634 and then extend outward having a horizontal edge 636 to an outer edge 638 of the side panel 630. The outer edge 638 is preferably rounded.

Each of the flanges 640 extend outward and have one or more holes 642, which extend through so as to attach or secure the bracket 600 to an interior portion of a vehicle panel and/or the bumper frame of the vehicle 102. In accordance with an exemplary embodiment, the bracket 600 is configured to receive a SAE J1772 electrical connector 210. The bracket 600 is preferably made from metal or metal-like material. By separating the bracket 600 from the door 400, a more secure connection can be made between the electrical connector 210 and the connection hardware 110, particularly with respect to flexible bumper materials.

In accordance with another embodiment, the connection hardware 110 can include communication hardware (not shown). The communication hardware can include a wireless transmitter and/or receiver hardware, Ethernet technology and wiring, or any other communication hardware. A person skilled in the art will appreciate that the connector hardware can comprise a variety of configurations and can be located at a variety of positions on the vehicle and that the configuration and location of the connector hardware 110 is not limited to embodiments specifically disclosed herein.

Some embodiments of a conversion kit can additionally include a cooling fan. The fan can be configured to create air flow over batteries or other components during heat generating use. More specifically, the fan can be configured, for example, to create air flow over batteries or other charging components during the battery charging process.

Some embodiments of a conversion kit can further comprise, for example, a battery management system (BMS). The battery management system (BMS) can interact with the original vehicle computers including any engine control units (ECU) or original battery management systems. The conversion BMS can integrate with any original ECU or BMS systems. In these embodiments, the conversion BMS can, for example, provide information relating to the charge state of the batteries to the original BMS.

In accordance with an exemplary embodiment, the BMS can control the charging and discharging of the batteries at the pack level. In other embodiments, the BMS can control the charging and discharging of the batteries at the cell level. In some aspects, the BMS can maintain an equal charge level in each cell during the charging or discharging of the battery. The BMS can maintain a charge equality ranging between +/−5 Vdc and +/−0.01 Vdc, such as, for example, +/−5 Vdc, +/−0.1 Vdc, or +/−0.07 Vdc. In other embodiments, the BMS can maintain a charge equality ranging between +/−5 percent and +/−0.01 percent, such as, for example, +/−5 percent, +/−1 percent, or +/−0.05 percent. Control of the batteries at the cell level can assist in maintaining uniform charge in each cell and uniform production from each cell. In accordance with an exemplary embodiment, control of the batteries at the cell level can significantly increase the life of the batteries as well as increases the overall battery capacity.

The BMS can additionally interact with the vehicle driver through the user interface display. The user interface display can be configured to be viewable by the vehicle operator while operating the vehicle. The user interface display can comprise input features and/or output features, the input features configured to allow the vehicle operator to input operation selections. A user interface display can further comprise a touch screen capable of displaying information and receiving user input. In accordance with an exemplary embodiment, the user interface display can display information relating to the vehicle operation mode and the duration of the trip. The user interface display can additionally, for example, display information relating to current vehicle performance, distance traveled since last charge or fill-up, mileage, vehicle errors, or current battery conditions. Some embodiments of possible user interface displays are depicted in FIGS. 6A-6E. The interface information can be viewed on an external computing system, for example, a handheld computing device, a laptop computer, and iPad® or similar device, a desktop computer, a mobile telephone, etc., to name a few examples. These devices can receive interface information via cable, wireless, or other connection.

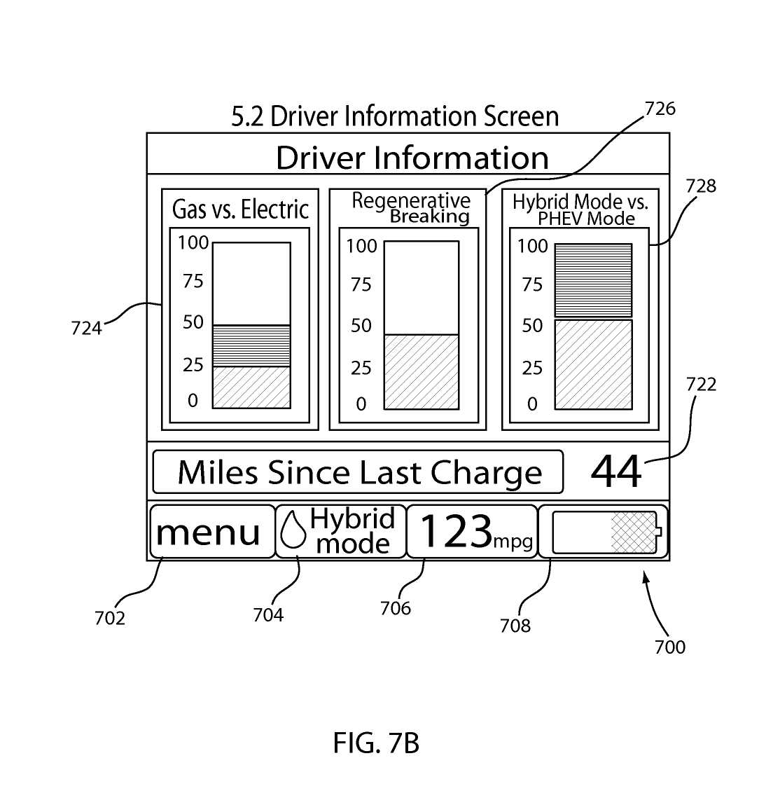

FIG. 7A depicts one example of a possible output of a user interface display 700. As depicted in FIG. 7A, the user interface display 700 contains touch fields 702, 704, 706, and 708 located at the bottom of the display, which fields enable the user to select display functions. As depicted in FIG. 7A, touch field 702 allows the vehicle operator to select the menu function, touch field 704 permits the vehicle operator to select the PHEV mode, touch field 706 allows the user to select functions relating to mileage, and touch field 708 permits the vehicle operator to select functions relating to the battery. In addition to the touch fields 702-708 located at the bottom of the display, FIG. 7A additionally depicts touch field Hybrid Mode 710, touch field PHEV Mode 712, and touch field EV Mode 714, all located within the mode row. FIG. 7A also depicts touch field Short 716, touch field Medium 718, and touch field Long 720, all located in the trip row. It should be noted that the depicted touch fields are merely examples of potential touch fields and that more or fewer fields can be utilized in any combination. In some aspects, two or more of the depicted fields can be combined together, for example, so that a single touch field has the functionality of two or more of the touch fields described herein. In addition, the locations of the fields can be changed so that the fields appear in any desired location.

FIG. 7B depicts a second example of a possible output of a user interface display. FIG. 7B depicts the same touch fields 702-708, located at the bottom of the user interface display, as depicted in FIG. 7A. FIG. 7B additionally depicts the distance the vehicle has traveled since its last charge 722, information relating to the relative energy taken from gasoline versus electric sources 724, the amount of energy harvested from regenerative breaking 726, and the comparative work done by the hybrid vehicle operation mode versus the PHEV vehicle operation mode 728. The depicted output is an example output and can be modified as desired to exclude any of the depicted items and/or to include additional items.

FIG. 7C depicts an additional example of a possible output of a user interface display. FIG. 7C depicts the same touch fields 702-708, located at the bottom of the user interface display, as depicted in FIG. 7A. FIG. 7C further displays information relating to distance traveled per unit of fossil fuel 730, and touch field for the display of information relating to distance traveled per unit of electricity 732. FIG. 7C additionally displays touch fields 734-740 which enable the user to select information relating to recent travel 734, travel on the current tank of fuel 736, travel in Trip A 738, and travel in Trip B 740. The depicted output is an example output and can be modified as desired to exclude any of the depicted items and touch fields, and/or to include additional items and/or touch fields.

FIG. 7D depicts an example of yet an additional possible output of a user interface display. FIG. 7D depicts the same touch fields 702-708, located at the bottom of the user interface display, as depicted in FIG. 7A. FIG. 7D further displays information relating diagnostic trouble codes (DTC). FIG. 7D includes a touch field labeled Clear All 742 for clearing the registered DTC codes and a touch field labeled Refresh 744 to recheck systems for DTC codes. FIG. 7D additionally depicts a vertically extending field DTC list field 746 located on the left side of the user interface display 700, the field containing a touch field for each detected DTC. Selection of an individual DTC in the DTC list field can, result in the display of information relating to the selected DTC in error field 748. The depicted output is an example output and can be modified as desired to exclude any of the depicted items and touch fields, and/or to include additional items and/or touch fields.

FIG. 7E depicts an example of an additional possible output of a user interface display 700. FIG. 7E depicts the same touch fields 702-708, located at the bottom of the user interface display, as depicted in FIG. 7A. FIG. 7E further displays information relating to performance of the electrical power systems in electric field 750 and the internal combustion engine (ICE) systems in ICE field 752. The displayed information can include output relating to battery charge and temperature. The displayed information can additionally include data relating to ICE power production, temperature, and available fuel. The depicted output is an example output and can be modified as desired to exclude any of the depicted items and touch fields, and/or to include additional items and/or touch fields.

In some embodiments in which the vehicle is operated, the vehicle systems can be powered with the starting of the vehicle. Upon starting the vehicle, the vehicle operator can, select between possible vehicle operation modes including, for example, the factory mode (e.g., the factor hybrid mode), the PHEV mode, or the True EV mode.

The factory mode (e.g., the factor hybrid mode) can be the original mode of operation of the vehicle. For example, that mode can be a gas/electric combination, which can utilize propulsion generated by the internal combustion system as well as from the electrical system.

The PHEV mode can be configured to generally use only electric propulsion, at any speed, unless additional power is required. Alternatively, the PHEV mode can be configured to use only electric propulsion at any speed below some designated speed, such as, for example, seventy-two miles per hour, unless additional power is required. A PHEV can be configured for use with an off-the-shelf engine control unit (ECU), such as, for example, a Hybrid Energy Manager (HEM) that controls the electric motor in the vehicle. In other embodiments, the PHEV can be configured for use with the original ECU. The BMS can provide the engine control unit information relating to available battery power and available power per unit time. The engine control unit can control the electric motor as well as the hybrid motor in light of this information relating to available power. Thus, in some aspects in which the conversion BMS provides less power than needed for desired vehicle performance, the conversion HEM can signal the hybrid motor to provide power to supplement the electric motor. More specifically, additional power may be required when the desired power requirements exceed some threshold level, such as, for example, during rapid acceleration or steep-uphill driving. In some aspects of a PHEV mode, additional power can be supplied by an internal combustion engine. Driving in the PHEV mode, can, for example, dramatically increase vehicle mileage. The mileage may approach approximately 100, 150, or 200 miles per gallon of fuel. The PHEV mode can transition to the hybrid mode when the vehicle battery drops below some predetermined threshold level.

In some additional embodiments of a PHEV mode, a vehicle operator can maximize vehicle performance by selecting “short,” “medium,” or “long” depending on the duration of the trip. The different trip durations can change the rate of battery discharge. Thus, in “short” mode, some embodiments of a conversion BMS can allow use of unlimited power per unit time until the battery reaches a minimum threshold, such as, for example, forty percent charge, twenty percent charge, ten percent charge, or five percent charge. Selection of “medium” or “long” can result in the BMS placing restrictions on the availability of power per unit time, thus increasing the likely duration of battery power during use. Thus, in one embodiment, the rate of battery discharge can be slower in the “long” trip configuration than in the “short” or “medium” trip configuration.

In some additional embodiments, battery discharge can be further facilitated by providing components to discharge the batteries after travel with the vehicle is concluded. In some embodiments, the batteries can be discharged by powering at least one resistor, at least one motor, or at least one other battery. The batteries can be discharged to a desired discharge level, such as, for example, approximately 60 percent discharged, approximately 77 percent discharged, approximately 90 percent discharged, approximately 99 percent discharged, or approximately 100 percent discharged. In some embodiments, batteries can be discharged to any discharge level in a range between 50 and 100 percent discharged. More specifically, a battery can be, for example, discharged to an approximately 1 to 40 percent state of charge or for example, to an approximately 23 percent state of charge. In some further embodiments, a battery can be, for example, discharged when its charge level is at or below a threshold level, such as, for example between 80 percent charge and 40 percent charge, or at or below 80 percent charge, 60 percent charge, or 40 percent charge. In one embodiment, a battery at or below 60 percent charge can be discharged to approximately 23 percent charge

More specifically, in one embodiment, the True EV discharge rates can be, for example, based on travel on flat roadway, with two passengers, and little or no head winds. In another aspect, EV discharge rates can be, for example, based on driving speed. A person of skill in the art will recognize that discharge rates will be based on a variety of factors such as engine size, vehicle weight, and vehicle aerodynamic factors as well as desired rates of discharge. Thus, vehicles traveling at speeds between 1 and 95 mph can have discharge rates between approximately 10 watt-hours per mile and 2 kilowatt-hours per mile. Thus, in one embodiment in which a vehicle is traveling 10 miles per hour (mph), the True EV discharge rate can be, for example, 180 watt-hours per mile and 20 A. In one embodiment in which a vehicle is traveling 20 mph, the True EV discharge rate can be, for example, 200 watt-hours per mile and 30 A. In one embodiment in which a vehicle is traveling 30 mph, the True EV discharge rate can be, for example, 230 watt-hours per mile and 40 A. In one embodiment in which a vehicle is traveling 40 mph, the True EV discharge rate can be, for example, 250 watt-hours per mile and 60 A. In one embodiment in which a vehicle is traveling 50 mph, the True EV discharge rate can be, for example, 300 watt-hours per mile and 80 A. In one embodiment in which a vehicle is traveling 60 mph, the True EV discharge rate can be, for example, 350 watt-hours per mile and 100 A. In one embodiment in which a vehicle is traveling 70 mph, the True EV discharge rate can be, for example, 425 watt-hours per mile and 120 A.

In accordance with an exemplary embodiment, use of different modes that correlate to the expected length of travel in a trip can, increase the effective capacity of the battery and increase the life of the battery by achieving frequent complete cycling of the battery. Additionally, correlation of power availability to expected trip length can, for example, increase vehicle mileage by increasing utilization of battery power in each trip.

True EV mode can be configured to generally use only electric propulsion, unless additional power is required. As discussed above, in this mode, the BMS can provide the engine control unit information relating to available battery power and available power per unit time. The engine control unit can control the electric motor as well as the internal combustion engine in light of this information relating to available power. Thus, in some aspects in which the conversion BMS provides less power than needed for desired vehicle performance, the conversion HEM can signal the hybrid motor to provide power to supplement the electric motor. More specifically, additional power may be required when the desired power requirements exceeds some threshold level, such as, for example, during extreme acceleration or extreme steep uphill. In contrast to the PHEV modes such as, for example, short, medium, or long, that can, in some aspects, be configured for electric only propulsion at any speed or at any speed below a predetermined speed such as, for example 50 to 80 mph, preferably about 72 mph, True EV mode can be configured to limit speed. Additionally, as discussed above, selection of PHEV mode and selection of expected trip length can, in some aspect, alter the rate at which the conversion BMS sets battery power usage. A person of skill in the art will recognize that the present disclosure is not limited to the specific, above-discussed trip lengths or modes of vehicle operation.

In accordance with an exemplary embodiment, control systems as described above and elsewhere herein significantly increase the usable storage capacity of the batteries used in the vehicle. For example, in some vehicles, this increase has more than doubled the effective battery capacity. In accordance with an exemplary embodiment, the original ECU and BMS are connected to the conversion BMS, depicted in block 702. This connection can enable the conversion BMS to provide information to the original ECU and BMS relating to battery conditions such as battery charge or battery temperature. Additionally, by interacting with the original ECU and BMS, performance of central vehicle functions can be performed by original equipment functioning under original conditions. The original ECU and BMS are also connected with the vehicle batteries.

In operation, the conversion BMS can request and receive signals relating to status of each component to which it is connected. For example, the conversion BMS can request information from the batteries relating to the state of charge, available power, or temperature. Such as, for example, when the battery temperature exceeds some threshold, the conversion BMS can request operation of the fan to create airflow to cool the batteries. A fan can communicatingly connect with the conversion BMS. When the conversion BMS can monitor battery temperatures and control the fan in light of measured battery temperatures. Thus, in one embodiment, for example, the fan can be activated when temperatures exceed approximately 130 degrees Fahrenheit, 122 degrees Fahrenheit, 113 degrees Fahrenheit, 110 degrees Fahrenheit, 93 degrees Fahrenheit, 78 degrees Fahrenheit, or 50 degrees Fahrenheit. The conversion BMS can use a variable speed fan operation, with low speed operation beginning when battery temperatures reach at least about 50 degrees, but more preferably about 78 degrees Fahrenheit and high speed fan operation for all battery temperatures exceeding about 85 degrees, more preferably about 93 degrees Fahrenheit. The conversion BMS can be further configured to stop charging and or signal an alarm when designated temperatures are achieved. Thus, in some embodiments of a battery in which cell degradation begins, for example, at 113 degrees Fahrenheit and in which major cell damage occurs at, for example, temperatures exceeding 122 degrees Fahrenheit, the conversion BMS can be configured to request stopping of charging and sounding of an alarm at, for example 110 degrees Fahrenheit.

In other aspects, such as, for example, during vehicle operation, if the battery level drops to or below some pre-determine state of charge, such as thirty percent, twenty-five percent, twenty-three percent, ten percent, five percent, or one percent, the conversion BMS can signal low battery power to the original BMS, which can, in some configurations, result in switching of vehicle operation mode from electric to hybrid operation including use of an internal combustion engine.

Similarly, the conversion BMS 702 can receive information from multiple sources and then, in light of the multiple signals, generate control requests. For example, in one embodiment, the conversion BMS can receive information from the user interface display relating to the desired mode of operation and desired trip distance. The conversion BMS can then request information relating to current battery conditions. Using information received from the user interface display and from the battery, the BMS can, according to preset criteria, select a vehicle operation mode. For example, if the vehicle operator inputs a long trip and EV mode of operation, the BMS can determine whether battery conditions are sufficient for such a trip request. In one embodiment, for example, a user may request PHEV operation mode and select a long trip. The BMS can, for example, query the batteries to determine their state of charge. In one embodiment in which the state of charge is at or below, for example, about ten to about thirty percent, preferably about twenty-three percent, the conversion BMS can deny the user request for operation in the PHEV mode configured for a long trip and signal vehicle operation in hybrid mode. In contrast, in another embodiment in which the battery state of charge is above, for example, about ten to about thirty percent, preferably about twenty-three percent, the conversion BMS can signal operation of the PHEV in True EV, long trip mode until the battery state of charge is too low, such as, for example, below twenty-three percent.

The PHEV can be configured with data tracking and recording features to track performance of different vehicle components. The conversion BMS can be, for example, configured to track data relating to battery performance, such as, for example, power demands on the battery, power availability, changes in state of charge, and battery temperature. A person of skill in the art will recognize that a variety of other battery variables can be tracked and recorded.

In some aspects, battery performance can be tested or verified through use of testing software or testing equipment. In some aspects, testing can be performed by requesting power from the conversion BMS and evaluating battery performance in light of the power requests. Power requests from the conversion BMS can be configured to match power requests taken from normal vehicle operation. Thus, in one aspect, BMS power requests occurring while driving the vehicle can be, for example, recorded and utilized during testing. In some aspects, battery usage and battery parameters tracked by a vehicle can, for example, be utilized during the test procedure. In such an embodiment, power can be requested from the battery in the same manner as was requested during the vehicle operation. In some further aspects of testing procedures, power extracted from the battery during testing can be dissipated through the use of resistive heaters, motors, or any other technique. A person skilled in the art will recognize that a variety of battery testing techniques, equipment, and procedures can be used and that the present disclosure is not limited to the above outlined embodiments.

In accordance with an exemplary embodiment, controlling the complete battery cycling, including battery state of charge achieved during charging and discharging, increases battery life and performance. Control of battery cycling can, for example, increase battery life by approximately thirty to fifty percent. In further embodiments, control of battery cycling can, for example, increase battery performance by approximately thirty to fifty percent. In one embodiment of battery cycling, a battery can be, for example, cycled through a normal cycle and through a deep cycle. A normal battery cycle can, for example, include charging the battery to a ninety percent state of charge. In further embodiments, a normal battery cycle can, for example, include discharging a battery to a ten to thirty percent, preferably about twenty-three percent state of charge. More specifically, in a battery configured for use in Toyota Prius, one embodiment of a normal battery cycle can comprise charging the battery to a ninety percent state of charge, 30 A-h capacity at two-hundred forty Vdc, and discharging the battery to a 23 percent state of charge, 6.9 A-h capacity at one-hundred ninety-five Vdc.

The conversion BMS can be, for example, configured to occasionally cycle the batteries through a deep cycle. In one embodiment, the conversion BMS can be configured to cycle the batteries through a deep cycle, for example, one a month, or once every twenty normal battery cycles. In one embodiment, the conversion BMS can, for example, be configured to discharge the battery to approximately three to 10 percent, preferably about five percent state of charge once every ten to fifty cycles, preferably every twenty cycles. More specifically, in a battery configured for use in Toyota Prius, one embodiment of a deep cycle can include discharging the batteries to a three to 10 percent, preferably about a five percent state of charge, 100.8 Vdc or approximately 0.6 Vdc per cell. The conversion BMS can communicate the state of charge of the vehicle's batteries and/or whether charging is desired, for example.

It should be noted that although a “conversion” BMS is mentioned in this and the following paragraphs, a BMS that is standard to a system or factory to a vehicle is also contemplated. For ease of reference, “conversion” BMS is used, but should not be construed as limiting the systems only to conversion BMS as any suitably configured BMS can be used and configured to have the described functionalities. In accordance with an exemplary embodiment, the conversion BMS can be connected to at least one temperature sensor. In other embodiments, a conversion BMS can be connected to an onboard charger that can, for example, be further connected to at least one temperature sensor. In one embodiment, a conversion BMS can be communicatingly connected with the onboard charger, which can be communicatingly connected with three temperature sensors, located throughout the batteries. The charger can charge the batteries and can, in some aspects, be configured for automatic shut-off when the batteries reach a predetermined voltage and a predetermined state of balance such as, for example three hundred Vdc, two-hundred forty Vdc, or one-hundred Vdc and about +/−5 to about +/−0.01 Vdc (preferably about +/−5 Vdc, +/−0.1 Vdc, or +/−0.07 Vdc) across all battery cells, or when any of the battery temperature sensors indicate a temperature above, for example, 60 degrees Celsius, 55 degrees Celsius, or 45 degrees Celsius. In embodiments in which charging stops upon reaching a voltage or temperature threshold such as, for example, three hundred Vdc, two-hundred forty Vdc, or one-hundred Vdc and about +/−5 to about +/−0.01 Vdc (preferably about +/−5 Vdc, +/−0.1 Vdc, or +/−0.07 Vdc) across all battery cells, or when any of the battery temperature sensors indicate a temperature above, for example, 60 degrees Celsius, 55 degrees Celsius, or 45 degrees Celsius.

In further embodiments of battery charging, a conversion BMS can monitor current flow into the battery. Additionally, the BMS can continuously, or at designated intervals, such as every minute, every second, or multiple times per second, request state of charge information from the battery. This information can, in some aspects, be stored in memory associated with the BMS and can, be used to provide the vehicle operator battery state of charge information upon start-up. The conversion BMS or the onboard charger can request that cooling fans located in the vehicle run during vehicle charging to maintain safe component temperatures, such as, for example, under 300 degrees Fahrenheit, under 200 degrees Fahrenheit, under 122 degrees Fahrenheit, under 113 degrees Fahrenheit, or under 110 degrees Fahrenheit. The conversion BMS or the onboard charger can request running of fans until charging is completed. In a similar manner, the conversion BMS or the onboard generator can request that cooling fans located in the vehicle run during vehicle power generation to maintain safe component temperatures, such as, for example, under 300 degrees Fahrenheit, under 200 degrees Fahrenheit, under 122 degrees Fahrenheit, under 113 degrees Fahrenheit, or under 110 degrees Fahrenheit. In some embodiments in which battery, component, or engine temperatures exceed such a temperature threshold, the engine can be configured to shutdown, automatically or upon request from a controller. A person skilled in the art will recognize that the charging is not limited to the specific embodiments disclosed herein.

In accordance with an exemplary embodiment, a carbon monoxide sensor can, for example, be configured to measure carbon monoxide levels in vehicle cabin air or in ambient air surrounding the vehicle. In some aspects, a carbon monoxide sensor can, for example, be configured to signal to stop the internal combustion engine when either ambient or cabin carbon monoxide levels exceed a threshold, such as, for example, a government determined safe carbon monoxide level. In some aspects, a carbon monoxide sensor can serve as a fail-safe in prevent operation of the internal combustion engine in areas that are unsuited to combustion.

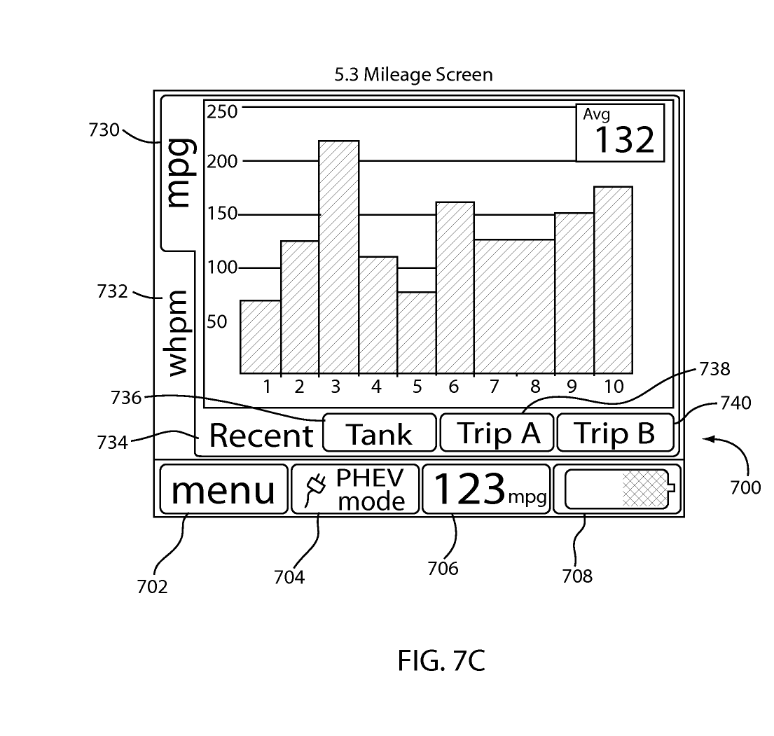

FIG. 8 illustrates a portable recharging kit 800, which provides a source of electricity for an electric vehicle (EV) and/or a plug-in electric vehicle (PEV) in accordance with an exemplary embodiment. As shown in FIG. 8, the portable recharging kit 800 includes an external source of electricity 810, which is preferably configured to fit within a trunk and/or other storage portion of an electric vehicle (EV) and/or plug-in electric vehicle (PEV) 102. The external source of electricity 810 is a battery or battery-like device 812, which holds and stores an electrical charge, which can be used to re-charge the electric vehicle 102 as needed. The external source of electricity 810 is preferably a device having suitable dimensions to be stored within the trunk and/or any other suitable storage compartment within the vehicle 102. For example, the external source of electricity 810 can be in the shape of a cube, a cylinder, and/or any other suitable shape. In accordance with an exemplary embodiment, the source of electricity 810 is preferably sized and/or dimensioned to fit within the trunk of the plug-in vehicle 102, and more preferably sized and/or dimensioned to fit within a designated portion of the trunk of the vehicle 102.

The external source of electricity 810 is preferably comprised of one or more electrochemical cells or other suitable chemical source, which can convert a source of chemical energy to an electrical energy source. The source of electricity 810 is preferably re-chargeable from an electrical charging station (e.g., wall plug) upon discharge or partial discharge of the source of electricity stored therein.

The external source of electricity 810 is also preferably sized to provide an electrical charge to the plug-in vehicle 102, which is sufficient to provide enough power to allow the vehicle 102 to locate a dedicated charging station, which can include a rapid charging station and/or alternatively, a home and/or base charging station. In accordance with an exemplary embodiment, the source of electricity is preferably designed to provide an electrical charge sufficient to travel approximately at least 1 to 10 miles, and more preferably at least 2 to 5 miles.

In accordance with an exemplary embodiment, the kit 800 also includes connection hardware 820. The connection hardware 820 preferably comprises an electrical charging connector, which is configured to engage an SAE J1772 compliant or dc equivalent electrical connector 104. The SAE J1772 compliant or dc equivalent electrical connector 104 preferably is connected to the external source of electricity via one or more cables 830. The external source of electricity 810 can be sized to remain within and/or fixed within the vehicle 102 and/or alternatively, the external source of electricity 810 can be removed from the vehicle 102 by hand and moved near and/or adjacent to the receptacle for the SAE J1772 complaint connector or dc equivalent electrical connector 104. If the external source of electricity 810 is configured to remain within a storage compartment within the vehicle 102, the one or more cables 830 have a length thereto that can engage the SAE J1772 compliant or dc equivalent electrical connector 104 without removing the external source of electricity 810 from the vehicle 102. In accordance with a further exemplary embodiment, the external source of electricity 810 can be wired (e.g., hardwired) to the operational batteries (not shown) of the electric and/or plug-in electrical vehicle 102 and can be controlled by a switch or switch-like device (e.g., A/B switch). For example, upon the need of the vehicle 102 for an additional source of electricity, the external source of electricity 810 is accessed via a switch or switch-like device (not shown).

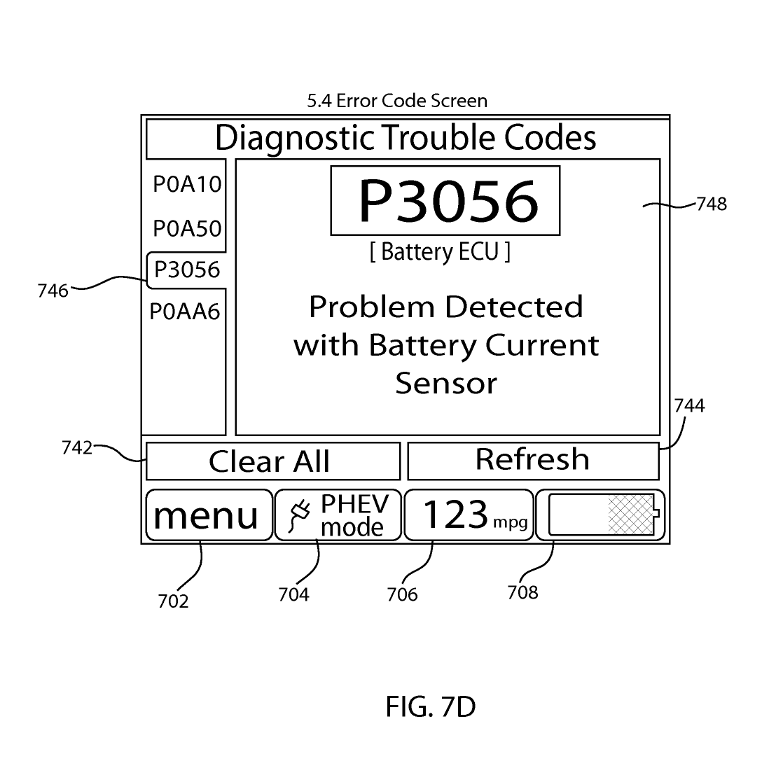

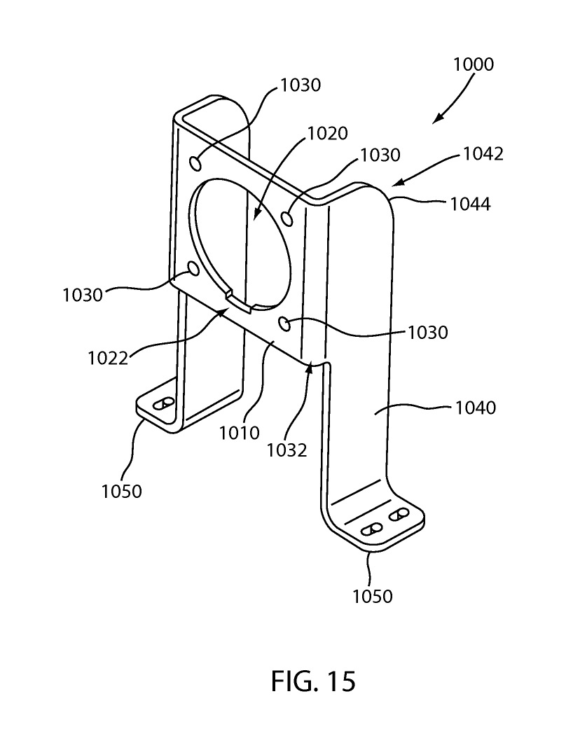

FIG. 9 illustrates a front panel frame assembly 900 mounted on a front bumper 106 of a plug-in electric vehicle 102, and which houses an electric vehicle supply equipment (EVSE) connector 104. As shown in FIG. 9, the front panel frame assembly 900 is configured to fit within the front bumper 106 of the electric vehicle 102. In accordance with an example, the electric vehicle supply equipment (EVSE) connector 104 is housed within a bracket 600, 1000 as shown in FIGS. 6 and 15, respectively.

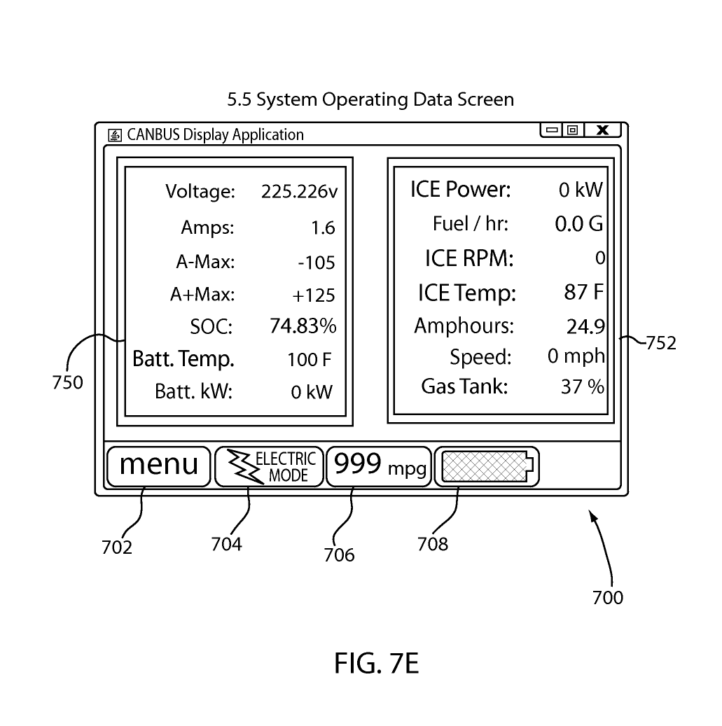

FIG. 10 illustrates the front panel frame assembly 900 as shown in FIG. 9 from a front side in accordance with an exemplary embodiment. The front panel frame assembly 900 is preferably attached to the front bumper 106 of the electrical vehicle 102, which houses the electrical connector 104. The electrical connector 104 can be an electrical charging connector, which is configured to engage an external SAE J1772 compliant or dc equivalent electrical connector (not shown). As shown in FIG. 10, the front panel frame assembly 900 includes a frame 902, a door 910, a back plate 920, a latch catch and magnet assembly 930, a hinge 940, and a hinge bracket 950. An emblem or badge 912 is preferably attached to the door 910 and serves as a cover for the electrical connector 104. For example, the emblem or badge 912 can be an identifier of the manufacturer of the vehicle, which is attached to the door 910. Alternatively, the door 910 can be the actual emblem or badge 912. For example, the door 910 can be a Toyota® emblem or badge 912. The frame assembly 900 allows the door 910 to swing outward from a closed position to expose the electric vehicle compliant connector 104, which is housed within the front bumper 106 of the electric vehicle 102 and recharges the electric vehicle as needed.

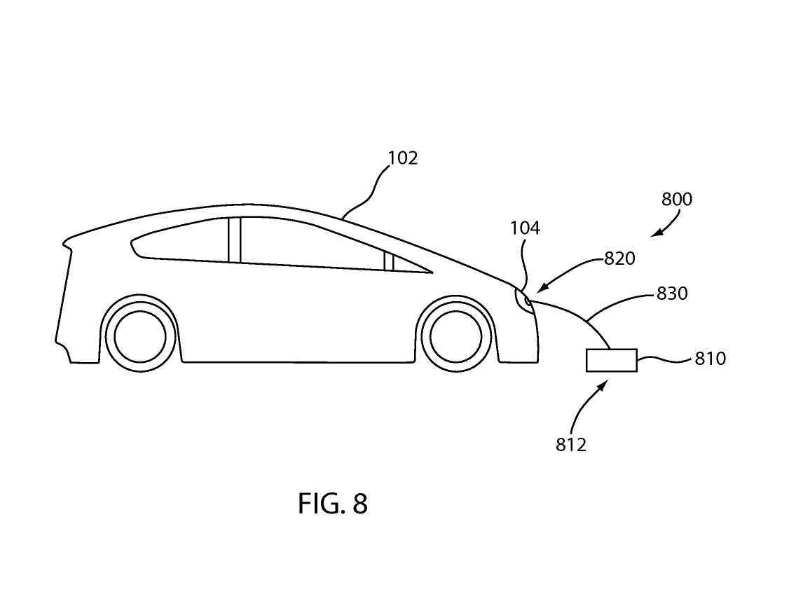

FIG. 11 illustrates the front panel frame assembly 900 as shown in FIG. 9 from a back side view. The front panel frame assembly 900 includes the door 910, the back plate 920, the latch catch and magnet assembly 930, the hinge bracket 940, and the hinge bracket 950. The assembly 900 also can include the emblem or badge 912, which in connection with the door 910 protects the electrical connector 104 from the elements. The assembly 900 also can include hardware, which connects the door 910 to the back plate 920 via the hinge 940 and the hinge bracket 950. The hardware can include a first set of one or more nuts (e.g., nylon) 960, a first set of one or more washers 962, a first set of one or more machine screws 964, a second set of one or more nuts (e.g., nylon) 966, a second set of one or more washers 968, and a second set of one or more machine screws 970.

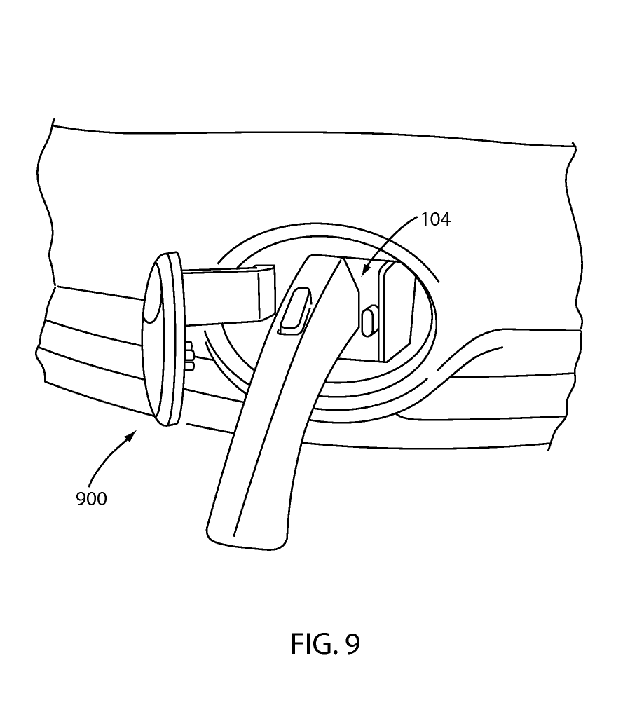

FIG. 12 illustrates a perspective view of the back plate 920 of the front panel frame assembly 900 as shown in FIGS. 10-11. As shown in FIG. 12, the back plate 920 includes an outer frame member 922 having an opening therein 921, which is configured to receive the external SAE J1772 compliant or dc equivalent electrical connector. The outer frame member 922 has a generally oval or round shape thereto with an inner bracket 924 extending perpendicular to an inner surface 923 of the opening therein 921. The inner bracket 924 is configured to attach to receive and/or attach to the latch catch and magnet assembly 930. The back plate 920 also includes an outer portion 925 having a plurality of openings therein, which are configured to receive the second set of the plurality of nuts and washers, which attaches the hinge bracket 950 to the back plate 920. The back plate 920 is preferably attachable or secured to an inner surface of the front bumper 106 of the vehicle 102 via one more openings therein using any suitable means of securing the back plate 920 to the front bumper 106.

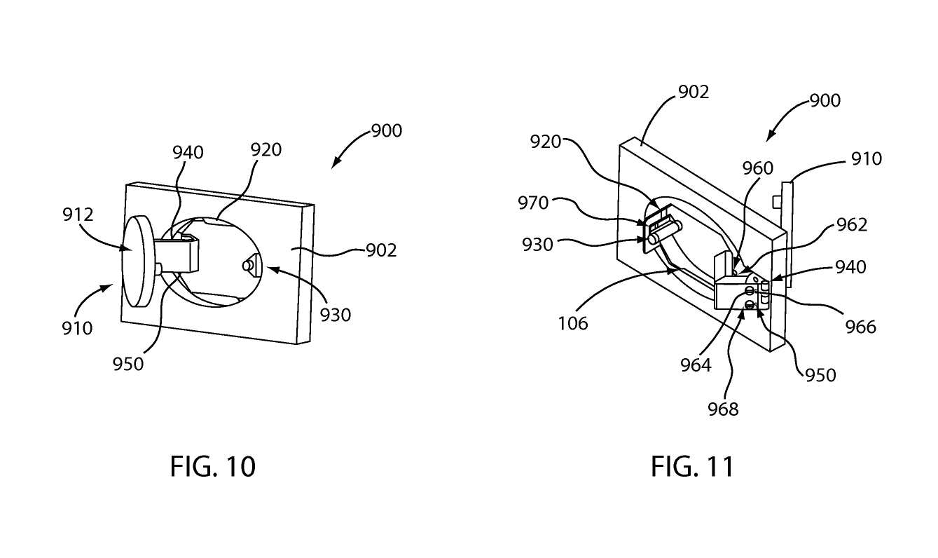

FIG. 13 illustrates a side view of the back plate 920. As shown in FIG. 13, the back plate 920 has a relatively flat cross-section. The inner bracket 924 portion of the back plate extends perpendicular to the outer frame member 922.

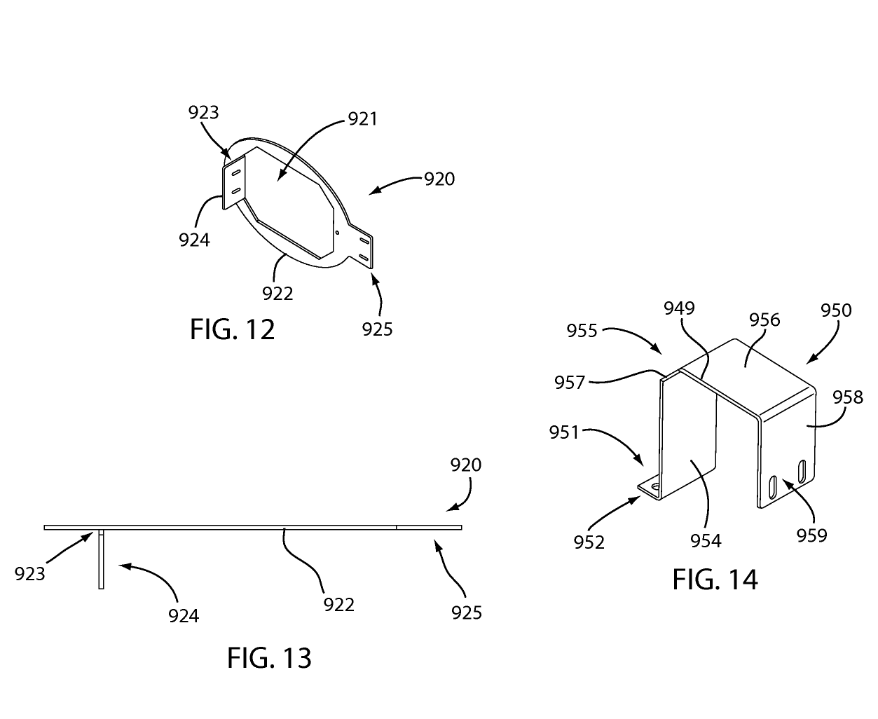

FIG. 14 illustrates a perspective view of the hinge bracket 950 in accordance with an exemplary embodiment. As shown in FIG. 14, the hinge bracket 950 includes an outer flange 952 having one or more openings therein 951, which are configured to receive one or more machine screws, one or more washers, and one or more locking nuts (not shown). A first plate 954 is attached to the outer flange 952 and extends perpendicular to the outer flange 952. The transition from the flange 952 to the first plate 954 is preferably slightly angled and/or rounded to provide a smooth transition from the flange 952 to the first plate 954. The hinge bracket 950 also includes a second plate 956, which extends from the first plate 954 via an angled transition plate 955. An inner surface 957 of the angle transition plate 955 form an angle of approximately 135 degrees with a lower surface of 949 of the second plate 956. The second plate 956 is preferably at a 90 degree angle to the first plate 954, and extends outward to a third plate 958. The transition from the second plate 956 to the third plate 958 is also preferably slightly angled and/or rounded to provide a smooth transition from the second plate 956 to the third plate 958. The third plate 958 includes one or more openings 959, which are configured to receive one or machine screws, one or more washers, and one or more locking nuts (not shown).

FIG. 15 illustrates a perspective view of a bracket 1000 for receiving an electrical connector for a plug-in electric vehicle (PHEV) and/or electric vehicle in accordance with an embodiment. As shown in FIG. 15, the bracket 1000 preferably includes relatively flat face plate 1010 having a connector opening 1020, which houses the electrical connector 210 (FIG. 3), and a plurality of openings 1030, which surround the connector opening 1020. The connector opening 1020 is generally circular with a slot 1022 on a lower edge thereof, which is configured to secure at least a portion of the electrical connector 210 and prevent the electrical connector 210 from rotating when connected to an SAE J1772 compliant or dc equivalent electrical connector. The plurality of openings 1030 are preferably configured to attach or secure the electrical connector 210 to the bracket 1000.

A pair of side panels 1040 are positioned at an approximate 90-degree angle to the plate 1010, and extends downward to flange 1050. The pair of side panels 1040 are generally rectangular with a rounded edge 1042 on an opposite edge 1044 from the face plate 1010. The transition 1032 from the face plate 1020 to the pair of side panels 1040 preferably has a slight curvature or roundness thereto rather than sharp edge. Each of the flanges 1050 extend outward and have one or more holes 1052, which extend through so as to attach or secure the bracket 1000 to an interior portion of a vehicle panel and/or the bumper frame of the vehicle 102. The transition from the pair of side panels 1040 to the flanges 1050 is preferably performed with a plate 1060 having a gradual curvature thereto. In accordance with an exemplary embodiment, the bracket 1000 is configured to receive a SAE J1772 electrical connector 102. The bracket 1000 is preferably made from metal or metal-like material. By separating the bracket 1000 from the door 400 or bumper 106, a more secure connection can be made between the electrical connector 210 and the connection hardware 110, particularly with respect to flexible door and/or bumper materials.

A person skilled in the art will recognize that each of these sub-systems can be inter-connected and controllably connected using a variety of techniques and hardware and that the present disclosure is not limited to any specific method of connection or connection hardware. One or more of the components depicted in the figures can, in some aspects, be excluded, and additional components can also be included, if desired. The technology is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like. As used herein, instructions refer to computer-implemented steps for processing information in the system. Instructions can be implemented in software, firmware or hardware and include any type of programmed step undertaken by components of the system.

A microprocessor may be any conventional general purpose single- or multi-chip microprocessor such as a Pentium® processor, a Pentium® Pro processor, a 8051 processor, a MIPS® processor, a Power PC® processor, or an Alpha® processor. In addition, the microprocessor may be any conventional special purpose microprocessor such as a digital signal processor or a graphics processor. The microprocessor typically has conventional address lines, conventional data lines, and one or more conventional control lines. The system may be used in connection with various operating systems such as Linux®, UNIX® or Microsoft Windows®. The system control may be written in any conventional programming language such as C, C++, BASIC, Pascal, or Java, and ran under a conventional operating system. C, C++, BASIC, Pascal, Java, and FORTRAN are industry standard programming languages for which many commercial compilers can be used to create executable code. The system control may also be written using interpreted languages such as Perl, Python or Ruby.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

The principles, preferred embodiments and modes of operation of the present invention have been described in the foregoing specification. However, the invention, which is intended to be protected, is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents, which fall within the spirit and scope of the present invention as defined in the claims be embraced thereby.

What is claimed is:

1. A kit for converting a standard hybrid vehicle into a plug-in hybrid vehicle (PHEV), the kit comprising:
at least one battery configured to match the voltage of an original hybrid battery;
connection hardware, wherein the connection hardware is configured to electrically connect the at least one battery to an off-vehicle power source; and
tangible computer readable memory media storing battery management software, wherein when executed in a processor in a vehicle, the battery management software is configured to provide information relating to battery performance to an engine control unit, wherein the at least one battery is further configured to maintain charge balance between each of the cells of the at least one battery.

2. The kit of claim 1, wherein the at least one battery is a 50 Ah, 201.6 Vdc battery; a 30 Ah, 201.6 Vdc battery; and/or a 6.5 Ah, 201.6 Vdc battery.

3. The kit of claim 1, wherein the battery management software is configured to manage the cell performance of the at least one battery.

4. The kit of claim 3, wherein the battery management software is configured to maintain a substantially equal charge across the cells of the at least one battery and the original hybrid battery.

5. The kit of claim 4, wherein the battery management software is configured to maintain an equal charge +/−0.07 Vdc across the cells of the at least one battery and the original hybrid battery.

6. The kit of claim 1, further comprising suspension components, wherein the suspension components include stiffer springs and/or shock absorbers with a higher damping coefficient.

7. The kit of claim 1, wherein the connection hardware is a flexible door having a frame and door, and a bracket, which houses an SAE J1772 compliant or dc equivalent electrical connector matable with the connection hardware.

8. A portable recharging kit for an electric vehicle, the kit comprising:
an external source of electricity, which is configured to be stored within the electric vehicle;
connection hardware, which is matable with an electric vehicle compliant connector; and
one or more cables, which connects the connection hardware to the external source of electricity.

9. The portable recharging kit of claim 8, wherein the electric vehicle compliant connector is an SAE J1772 compliant or dc equivalent connector.

10. A panel assembly, which is configured to fit within a front bumper of an electrical vehicle, comprising:
a back plate, which is attachable to an inner portion of the front bumper;
a door assembly, which is attachable to the back plate, the door assembly including a door, a latch catch and magnet assembly, a hinge, and a hinge bracket, which allows the door to swing outward from a closed position to expose an electric vehicle compliant connector, which is housed within the front bumper of the electric vehicle and recharges the electric vehicle as needed.

11. The front panel assembly of claim 10, wherein the door is an emblem or badge of a manufacturer of the electric vehicle.

12. A method of increasing the performance of at least one battery configured for use in a PHEV, wherein the at least one battery is configured with the same maximum voltage as an original vehicle battery, the method comprising:
controllably cycling the charging and discharging of the at least one battery, the cycling comprising:
battery charging, wherein the at least one battery is charged to a first state of charge in charging cycling, and
discharging, wherein discharging comprises:
regular discharging, wherein the at least one battery is discharged to second state of charge, and
deep discharging, wherein the at least one battery is discharged to a third state of charge.

13. The method of claim 12, wherein the first state of charge comprises an approximately 90 percent state of charge.

14. The method of claim 12, wherein the second state of charge comprises an approximately 23 percent state of charge.

15. The method of claim 12, wherein the third state of charge comprises a 5 percent state of charge.

16. The method of claim 12, wherein the battery cycle comprises one deep discharge cycle for at least every twenty regular discharge cycles.

17. The method of claim 12, wherein the battery cycle comprises one deep discharge cycle every month.

18. A method of maximizing battery usage in a PHEV, wherein the cycling of a vehicle battery increases battery performance and battery life, the method comprising:
requesting vehicle operator input relating to desired vehicle operation mode; requesting vehicle operator input relating to estimated trip length;
requesting information relating to battery charge parameters;
allowing vehicle operation in the user requested mode when battery criteria exceed threshold levels;
denying vehicle operation in the user requested mode when battery criteria fail to exceed threshold levels; and
limiting a rate of battery power availability according to predetermined criteria, wherein the predetermined criteria are created to maximize ideal cycling of the vehicle battery during each trip, wherein ideal cycling comprises discharging the vehicle battery from a first state of charge to a second state of charge.

19. The method of claim 18, wherein the first state of charge comprises a 90 percent state of charge.

20. The method of claim 18, wherein the second state of charge comprises a 23 percent state of charge.

21. The method of claim 18, wherein the desired vehicle operation mode comprises the factory vehicle operation mode.

22. The method of claim 18, wherein the desired vehicle operation mode comprises limiting vehicle top speed.

23. The method of claim 18, wherein the desired vehicle operation mode comprises solely electric power below a designated speed.

24. The method of claim 18, wherein the vehicle operation mode uses solely electric power below 72 miles per hour.
